(19) United States
(12) Patent Application Publication
(10) Pub. No.: US 2015/0081953 A1
(43) Pub. Date: Mar. 19, 2015

(54) SSD (SOLID STATE DRIVE) DEVICE

(71) Applicant: BUFFALO MEMORY CO., LTD., Nagoya-shi, Aichi (JP)

(72) Inventors: Yosuke Takata, Nagoya-shi (JP); Takayuki Okinaga, Nagoya-shi (JP); Noriaki Sugahara, Nagoya-shi (JP)

(73) Assignee: BUFFALO MEMORY CO., LTD., Nagoya-shi, Aichi (JP)

(21) Appl. No.: 14/399,004

(22) PCT Filed: Mar. 27, 2013
(86) PCT No.: PCT/JP2013/059058

§ 371 Date: Nov. 5, 2014

(30) Foreign Application Priority Data
May 7, 2012 (JP) 2012-106260

(51) Int. Cl. G06F 12/02

(52) U.S. Cl. CPC G06F 12/0246; G06F 2212/1028; G06F 2212/2022; G06F 2212/222
USPC 711/103

(57) ABSTRACT

The present invention provides an SSD device that uses non-volatile memory as a cache to contribute to reduced power consumption.

An SSD (Solid State Drive) device using a flash memory includes n (n≧2) non-volatile memory units 130 and a controller section 11. Each of the non-volatile memory units 130 includes a non-volatile memory different in type from a flash memory. The controller section 11 receives data to be written to the flash memory and stores the received data in the non-volatile memory units 130.

### TECHNICAL FIELD

The present invention relates to an SSD device using flash memory such as NAND flash memory.

### BACKGROUND ART

Recent years have seen the use of SSD (Solid State Drive) devices in place of hard disk drives (HDDs) for their high throughput and low power consumption. Further, DRAM (Dynamic Random Access Memory) is used in some cases as a cache memory to provide higher read and write speed.

It should be noted that both Patent Documents 1 and 2 disclose that magnetoresistive random access memory (MRAM) can be used as a cache memory in addition to DRAM.

### PRIOR ART DOCUMENTS

### Patent Documents

[Patent Document 1]

U.S. Pat. No. 7,003,623 Specification

[Patent Document 2]

Japanese Patent Laid-Open No. 2011-164994

### SUMMARY OF THE INVENTION

### Problem to be Solved by the Invention

The above conventional SSD having a DRAM cache requires refresh of the DRAM, thus making it difficult to reduce standby power. On the other hand, non-volatile memory such as magnetoresistive random access memory can be theoretically used as a cache memory substituted for DRAM. In reality, however, non-volatile memory cannot achieve the read and write speed which is achieved using DRAM, making the read and write speed of non-volatile memory slower than the speed of the host-side interface (e.g., when an MRAM with a 25 MHz base clock is used, four-byte access, for example, results in 25×4=100 MB/s, which is slower than 133 MB/s required by PATA (Parallel Advanced Technology Attachment)). With this speed, non-volatile memory cannot be used as a cache memory.

The present invention has been devised in light of the foregoing, and it is an object of the present invention to provide an SSD device using non-volatile memory as a cache memory so as to provide reduced power consumption.

### Means for Solving the Problem

In order to solve the above conventional problem, the present invention is an SSD (Solid State Drive) device using flash memory. The SSD device includes n (n≧2) non-volatile memory units and a controller. Each of the non-volatile memory units includes a non-volatile memory different in type from a flash memory. The controller receives data to be written to the flash memory and stores the received data in the non-volatile memory units.

Here, the controller may divide the data to be written to the flash memory into m (2≦m≦n) pieces to generate divided data and write each of the m pieces of divided data obtained by the division to one of the n non-volatile memory units. Alternatively, the controller may divide the data to be written to the flash memory into m (2≦m≦n) pieces to generate divided data and write each of the m pieces of divided data obtained by the division to one of the n non-volatile memory units while at the same time switching between the n non-volatile memory units, one after another, as the target memory units.

Still alternatively, the controller may divide an error correction code, attached to the data to be written to the flash memory, into m (2≦m≦n) pieces to generate divided data and write each of the m pieces of divided data obtained by the division to one of the n non-volatile memory units.

Still alternatively, the controller may include a storage section that includes a volatile memory. When determining that the SSD device should be placed in standby mode, the controller interrupts the supply of power to the non-volatile memory units and the storage section after reading data stored in the storage section and writing the data to the non-volatile memory units. Still alternatively, when determining that the SSD device should be restored to normal mode, the controller may read data that has been written to the non-volatile memory units and store the data in the storage section after initiating the supply of power to the non-volatile memory units and the storage section.

### Effect of the Invention

The present invention allows for data to be read and written in a concurrent or time-divided manner by using a plurality of non-volatile memory units, thus providing higher read and write speed and permitting non-volatile memory to be used as a cache memory.

### BRIEF DESCRIPTION OF THE DRAWINGS

FIG. 1 is a schematic block diagram illustrating a configuration example of an SSD device according to an embodiment of the present invention.

FIG. 2 is a block diagram illustrating an example of components of a controller section of the SSD device according to the embodiment of the present invention.

FIG. 3 is an explanatory diagram illustrating an example of connection between a cache control section and non-volatile memory units of the SSD device according to the embodiment of the present invention.

FIG. 4 is an explanatory diagram illustrating another example of connection between the cache control section and the non-volatile memory units of the SSD device according to the embodiment of the present invention.

FIG. 5 is a flowchart illustrating an operation example of a CPU during a write operation of the SSD device according to the embodiment of the present invention.

FIG. 6 is a schematic timing chart of a write operation of the SSD device according to the embodiment of the present invention.

FIG. 7 is a flowchart illustrating an example of control handled by the controller section of the SSD device according to the embodiment of the present invention.

### MODE FOR CARRYING OUT THE INVENTION

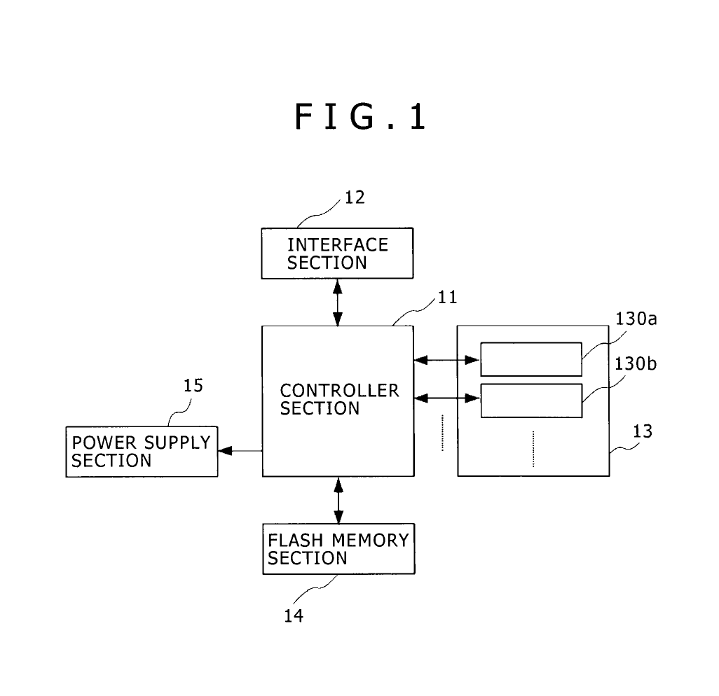

A description will be given below of an embodiment of the present invention with reference to the accompanying drawings. An SSD device 1 according to the embodiment of the present invention includes a controller section 11, an interface section 12, a cache memory section 13, a flash memory section 14, and a power supply section 15 as illustrated in FIG. 1. The SSD device 1 is connected to a host (device that uses the SSD device, such as computer) via the interface section 12.

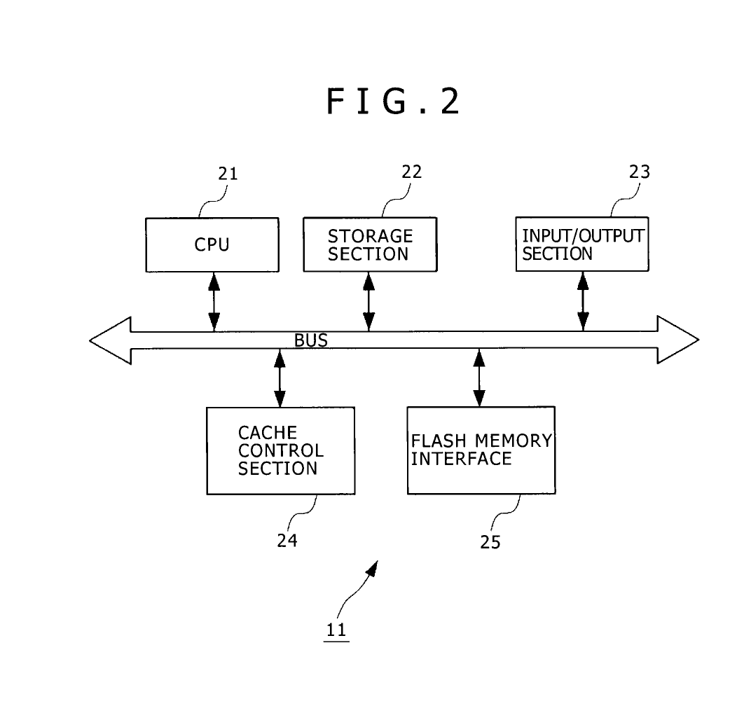

The controller section 11 is a program-controlled device that operates according to a stored program. More specifically, the controller section 11 includes a CPU 21, a storage section 22, an input/output section 23, a cache control section 24, and a flash memory interface 25 as illustrated in FIG. 2.

Here, the CPU 21 operates according to a program stored in the storage section 22. In the present embodiment, the CPU 21 reads data from or writes data to the cache memory section 13 or the flash memory section 14 according to an instruction supplied from the host via the input/output section 23. The specific details of processes performed by the CPU 21 will be described later.

The storage section 22 of the controller section 11 is, for example, a volatile memory such as SRAM (Static Random Access Memory) and holds a program such as firmware executed by the CPU 21. It should be noted that this firmware may be stored in a non-volatile memory such as NOR flash which is not shown so that the NOR flash is connected to the controller section 11 and the firmware is read from the NOR flash and stored in the storage section 22. Alternatively, this firmware may be stored in a computer-readable storage medium such as DVD-ROM (Digital Versatile Disc Read Only Memory) or supplied from the host and copied to the storage section 22.

The input/output section 23 is connected to the interface section 12, controlling communication between the CPU 21 and the host via the interface section 12. The input/output section 23 is, for example, a SATA (Serial Advanced Technology Attachment)-PHY.

The cache control section 24 writes data to or reads data from the cache memory section 13 in accordance with an instruction supplied from the CPU 21. Upon receipt of a data write instruction from the CPU 21, the cache control section 24 attaches an error correction code to data to be written and writes the data including the error correction code to the cache memory section 13. Further, the cache control section 24 corrects data errors using the error correction code included in the data that has been read from the cache memory section 13 in accordance with a read instruction supplied from the CPU 21, outputting the error-corrected data to the transfer destination address in accordance with the instruction from the CPU 21. The flash memory interface 25 writes data to or reads data from the flash memory section 14 in accordance with an instruction supplied from the CPU 21.

The interface section 12 is, for example, a SATA or PATA (Parallel Advanced Technology Attachment) interface connector and connected to the host. The interface section 12 receives a command or data to be written from the host and outputs the received command or data to the controller section 11. Further, the interface section 12 outputs, for example, data supplied from the controller section 11, to the host. Still further, for example, if the input/output section 23 included in the controller section 11 is a SATA-PHY, and if the interface section 12 is a PATA interface connector, a module may be provided between the controller section 11 and the interface section 12 to convert protocols between PATA and SATA.

The cache memory section 13 includes a non-volatile memory different in type from flash memory. Among such non-volatile memories are FeRAM (Ferroelectric RAM) and MRAM (Magnetoresistive RAM). In the present embodiment, the cache memory section 13 includes n (n≧2) non-volatile memory units 130a, 130b, and so on. Each of the non-volatile memory units includes a non-volatile memory different in type from flash memory. The cache memory section 13 holds data in accordance with an instruction supplied from the controller section 11. Further, the cache memory section 13 reads held data and outputs the data to the controller section 11 in accordance with an instruction supplied from the controller section 11.

The flash memory section 14 includes, for example, a NAND flash. The flash memory section 14 holds data in accordance with an instruction supplied from the controller section 11. Further, the flash memory section 14 reads held data and outputs the data to the controller section 11 in accordance with an instruction supplied from the controller section 11.

The power supply section 15 selectively permits or interrupts the supply of power to various sections in accordance with an instruction supplied from the controller section 11.

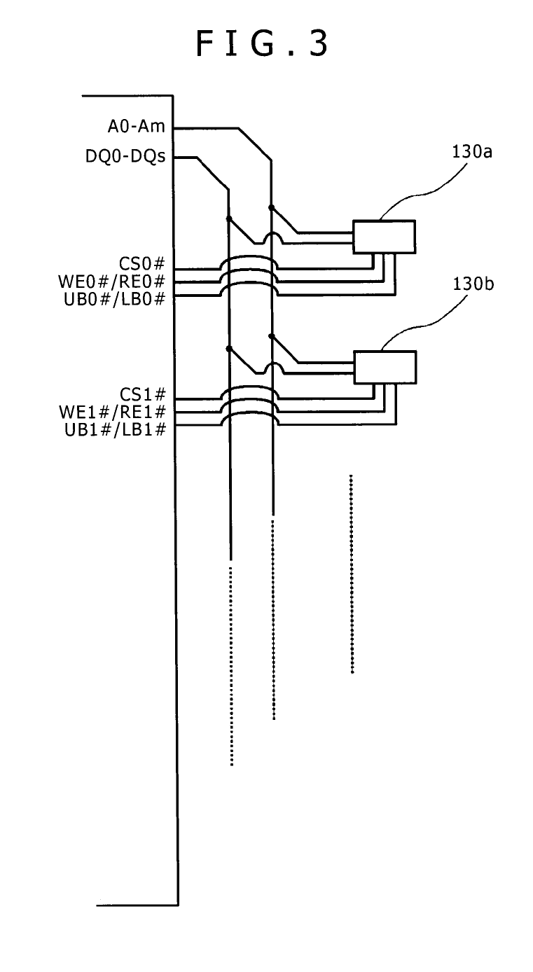

In the present embodiment, device select signal lines CS0#, CS1#, and so on, upper byte select signal lines UB0#, UB1#, and so on, lower byte select signal lines LB0#, LB1#, and so on, device write enable signal lines WE0#, WE1#, and so on, and device read enable signal lines RE0#, RE1#, and so on, each associated with one of the plurality of non-volatile memory units 130a, 130b, and so on, are led out from the cache control section 24 of the controller section 11 and connected to the associated one of the non-volatile memory units 130a, 130b, and so on, as illustrated in FIG. 3. It should be noted that the write and read enable signal lines, and the upper and lower byte select signal lines, may be each a single signal line. In this case, which of write and read is enabled is determined by the signal level (high or low). Further, which of upper and lower bytes is selected is determined by the signal level (high or low).

Further, address signal lines (A0 to Am) and data signal lines (DQ0 to DQs) are led out from the cache control section 24. Of these, the address signal lines are connected to each of the non-volatile memory units 130a, 130b, and so on. As for the data signal lines, on the other hand, different (s+1)/n (assumed to be an integer) bits each of the s-bit signal lines are connected to one of the non-volatile memory units 130a, 130b, and so on. As an example, if the two non-volatile memory units 130a and 130b are used (where n=2), and if the data signal line width (s+1) is 32 bits, the signal lines DQ0 to DQ15 for (s+1)/n=32/2=16 bits of the signal lines DQ0 to DQ31 are connected to the non-volatile memory units 130a, 130c, and so on. Then, the signal lines DQ16 to DQ31 for the remaining 16 bits are connected to the non-volatile memory units 130b, 130d, and so on.

In this example, upon receipt of a data write instruction from the CPU 21, the cache control section 24 outputs information indicating a write destination address to the address signal lines. Then, the cache control section 24 asserts all the device select signal lines CSn# associated with each of the non-volatile memory units 130a, 130b, and so on, and enables all the device write enable signal lines WEn#. It should be noted that if the upper and lower bytes are controlled separately, all the upper byte select signal lines UBn# and lower byte select signal lines LBn# associated with each of the non-volatile memory units 130a, 130b, and so on, are enabled.

Then, the cache control section 24 outputs data (32 bits wide) to be written to the data signal lines. MRAM or other memory included in each of the non-volatile memory units 130a, 130b, and so on, loads the data from the data signal lines DQ in a given period of time after the write enable signal lines WEn# and so on are enabled following the assertion of the device select signal lines CSn#, and writes the data to the address supplied through the address signal lines. At this time, the data signal lines DQ0 to DQj (j=(s+1)/n) are connected to the non-volatile memory unit 130a, and the data signal lines DQ(j+1) to DQ(2j+1) (j=(s+1)/n) are connected to the non-volatile memory unit 130b. Thus, data is stored in the non-volatile memory unit 130a, 130b, and so on in a divided manner.

That is, in this example of the present embodiment, the cache control section 24 generates m=n pieces of divided data because of the connection described above. As a result, the m pieces of divided data obtained by the division are written respectively to the n non-volatile memory units 130a, 130b, and so on.

Further, upon receipt of a data read instruction from the CPU 21, the cache control section 24 in this example outputs information indicating the address where the data to be read is stored to the address signal lines. Then, the cache control section 24 asserts all the device select signal lines CSn# associated with each of the non-volatile memory units 130a, 130b, and so on, and enables all the device read enable signal lines REn#.

MRAM or other memory included in each of the non-volatile memory units 130a, 130b, and so on, outputs read data to the data signal lines DQ# in a given period of time after an address has been output to the address signal lines. For this reason, the cache control section 24 loads the data from the data signal lines DQ# in a given period of time after the address has been output to the address signal lines. At this time, the data signal lines DQ0 to DQj (j=(s+1)/n) are connected to the non-volatile memory unit 130a, while the data signal lines DQ (j+1) to DQ(2j) (j=(s+1)/n) are connected to the non-volatile memory unit 130b. Therefore, data resulting from connection of data of each of the bits obtained from the non-volatile memory units 130a, 130b, and so on, in this order appears in the data signal lines DQ0 to DQs. The cache control section 24 extracts this data and outputs it to the transfer destination address in accordance with the instruction from the CPU 21.

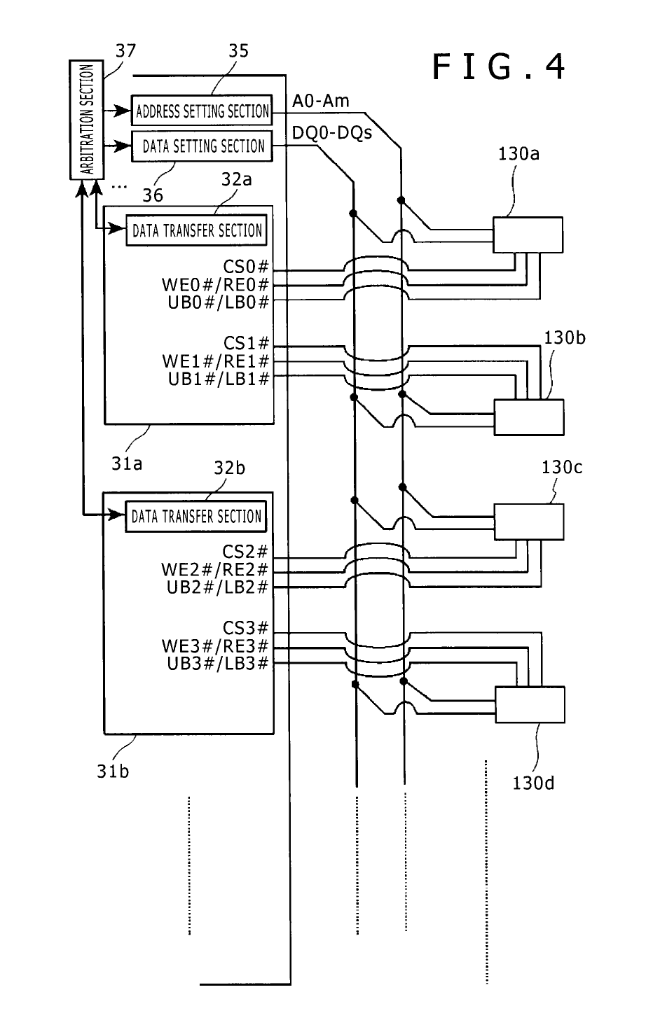

In another example of the present embodiment, the cache control section 24 of the controller section 11 may include channel control sections 31a, 31b, and so on, and an address setting section 35, a data setting section 36, and an arbitration section 37 as illustrated in FIG. 4. The channel control sections 31a, 31b, and so on, control a plurality of channels. The address setting section 35, the data setting section 36, and the arbitration section 37 may be shared by all the channels. The cache memory section 13 may be connected to each of the channels. Each of the channel control sections 31a, 31b, and so on, includes one of data transfer sections 32a, 32b, and so on, that are independent of each other. Each of the data transfer sections 32 includes, for example, a DMAC (Direct Memory Access Controller) and transfers data from a specified address of the storage section 22 to a specified address of the non-volatile memory unit 130 of the associated channel.

The address setting section 35 outputs, to the address signal lines A0 and so on, a signal indicating the address specified by one of the data transfer sections 32. The address setting section 35 does not receive an address specified by any of the other data transfer sections 32 until informed by the data transfer section 32 that has specified the address that the data transfer is complete.

The data setting section 36 receives the address in the storage section 22 specified by one of the data transfer sections 32, reading data stored at the position of the storage section 22 indicated by the address, and outputting the data to the data signal line DQ0 and so on.

The arbitration section 37 determines which of the data transfer sections 32 is to specify an address to the address setting section 35. The arbitration section 37 has a memory adapted to store a queue. Upon receipt of a request to specify an address from one of the data transfer sections 32, the arbitration section 37 holds, at the end of the queue, information identifying the data transfer section 32 that has made the request. Further, the arbitration section 37 permits the data transfer section 32 identified by the information at the beginning of the queue to specify an address. When the data transfer section 32 identified by the information at the beginning of the queue outputs information indicating the end of transfer, the arbitration section 37 deletes the information identifying this data transfer section 32 from the beginning of the queue and continues with the process.

On the other hand, an equal number p (p≧1) each of the plurality of non-volatile memory units 130a, 130b, and so on (i.e., when the number of channels is CN, n=p×CN), is assigned to one of the channels. In an example of the present embodiment, the non-volatile memory units 130a and 130b are assigned to a first channel, and the non-volatile memory units 130c and 130d are assigned to a second channel.

Further, each of the device select signal lines CS0#, CS1#, and so on, the upper byte select signal lines UB0#, UB1#, and so on, the lower byte select signal lines LB0#, LB1#, and so on, the device write enable signal lines WE0#, WE1#, and so on, and the device read enable signal lines RE0#, RE1#, and so on, associated with one of the plurality of non-volatile memory units 130a, 130b, and so on, is led out from the associated one of the channel control sections 31a, 31b, and so on, and connected to the associated one of the non-volatile memory unit 130a, 130b, and so on. For example, in the previous example, the signal lines CS0#, UB0#, LB0#, WE0#, and RE0# that are associated with the non-volatile memory unit 130a are led out from the channel control section 31a that is associated with the first channel. The signal lines CS2#, UB2#, LB2#, WE2#, and RE2# that are associated with the non-volatile memory unit 130c are led out from the channel control section 31b that is associated with the second channel.

Further, the address signal lines (A0 to Am) and the data signal lines (DQ0 to DQs) are led out from the cache control section 24. Of these, the address signal lines are connected to each of the non-volatile memory units 130a, 130b, and so on. As for the data signal lines, on the other hand, different s/p (assumed to be an integer) bits each of the s-bit signal lines are connected to one of the non-volatile memory units 130a, 130b, and so on. As an example, if the two non-volatile memory units 130 are associated with each channel as described above, and if s is 32 bits, the signal lines DQ0 to DQ15 for 32/2=16 bits of the signal lines DQ0 to DQ31 are connected to the non-volatile memory units 130a, 130c, and so on. Then, the signal lines DQ16 to DQ31 for the remaining 16 bits are connected to the non-volatile memory units 130b, 130d, and so on.

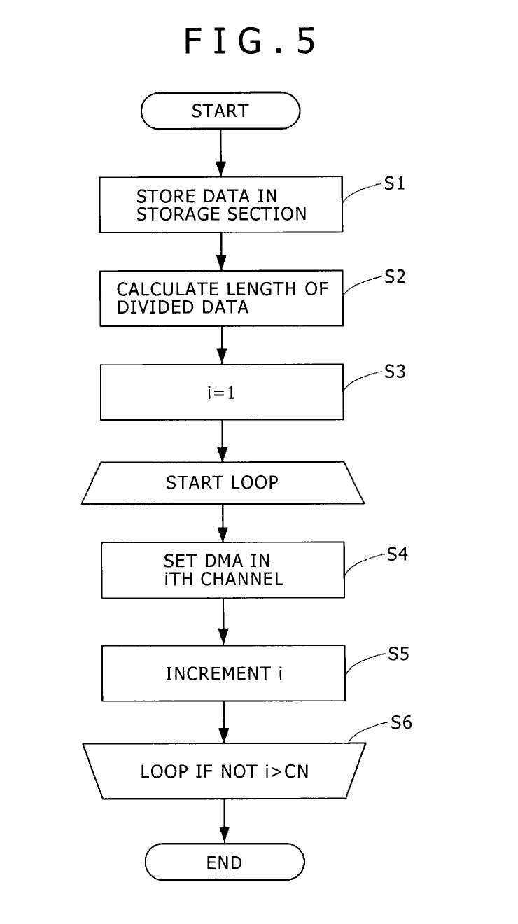

In this example, upon receipt of a data write instruction (command involving data write) and data to be written from the host, the CPU 21 divides the data into data blocks of a given size as illustrated in FIG. 5.

More specifically, the CPU 21 stores the received data in a free space of the storage section 22 (S1) and calculates, as the length of the divided data, the value, BL=L/CN, by dividing L with CN, where CN is the number of write destination channels, and L is the length of the received data (S2).

Then, the CPU 21 resets a counter “i” to “1” (S3) and sets the address of the memory of the storage section 22, the transfer source (transfer source address), the address of the non-volatile memory of the non-volatile memory unit 130, the transfer destination (transfer destination address), and the data length BL of the divided data serving as the length of the data to be transferred, in the DMAC of a data transfer section 32i of the channel control section 31i associated with the ith channel (DMA setting process: S4).

Here, a transfer source address Asource is calculated by Asource=As+(i−1)×BL where As is the start address of the free area where the data was stored in step S1. On the other hand, the transfer destination address need only be determined in relation to the LBA (Logical Block Address) included in the command involving data write. The transfer destination address can be determined using a well-known method for managing cache memories. Therefore, a detailed description is omitted here. The CPU 21 stores the LBA, the write destination channel, and the transfer destination address, in association with each other.

When the DMA setting process for the ith channel is complete, the CPU 21 increments “i” by “1” irrespective of the data transfer condition by the DMAC (S5) and checks whether or not “i” has exceeded CN (whether i>CN) (S6). Here, if “i” is not greater than CN, control returns to step S4 to proceed with the DMA setting process for the next channel.

On the other hand, if i>CN in step S6, control exits from the loop to begin other process.

The data transfer section 32i begins transfer of data of the specified length from the specified address to the associated non-volatile memory unit 130. This process is more specifically as follows. The data transfer section 32i requests address specification to the arbitration section 37. When permitted by the arbitration section 37 to specify an address, the data transfer section 32i outputs the transfer destination address set by the DMA setting process to the address setting section 35.

Further, the data transfer section 32i asserts all the device select signal lines CSn# connected to the channel control section 31i of the associated ith channel and enables all the device write enable signal lines WEn#. It should be noted that if the upper and lower bytes are controlled separately, all the upper byte select signal lines UBn# and lower byte select signal lines LBn# associated with each of the non-volatile memory units 130a, 130b, and so on, are enabled.

Then, the data transfer section 32i outputs the transfer source address to the data setting section 36. As these operations are performed at given times, data is written to the non-volatile memory units 130 of the ith channel.

From here onward, the data transfer section 32i repeats the above operations while at the same time incrementing the transfer destination address and the transfer source address until as much of the data as corresponding to the data length BL is completed to be written. Then, when as much of the data as corresponding to the data length BL is completed to be written, the data transfer section 32i outputs, to the arbitration section 37, a signal indicating the end of data transfer. The data transfer section 32i performs a given end time process (e.g., setting end status information) and then outputs, to the CPU 21, an interrupt signal indicating the end of data transfer.

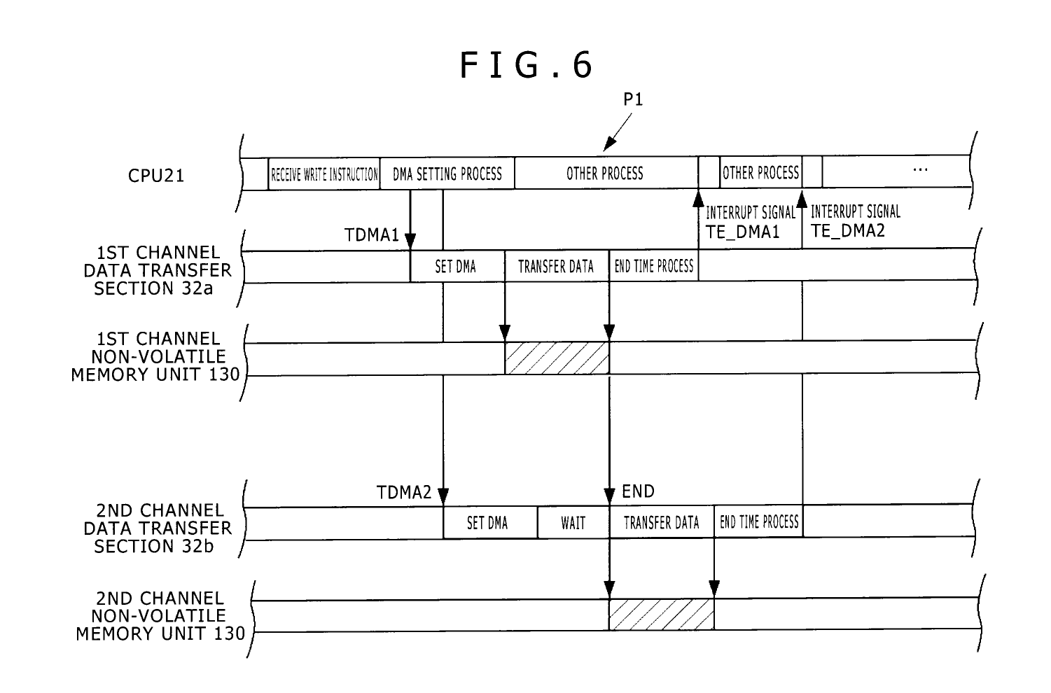

As a result of the above operations, in the SSD device 1 according to this example of the present embodiment, the CPU 21 performs the DMA setting process on the data transfer sections 32 of each channel subject to data write, one after another (TDMA1, TDMA2, and so on), when data is written as illustrated in FIG. 6. The CPU 21 does so irrespective of the progress of data transfer by each of the data transfer sections 32.

Then, after having completed the DMA setting process on each channel, the CPU 21 can perform other process even when data transfer by the data transfer section 32 is in progress (P1).

The data transfer section 32a of the first channel transfers data to the non-volatile memory units 130a and 130b of the first channel. When data transfer is complete, the data transfer section 32a controls various sections (notifies the arbitration section 37 that data transfer is complete in the above example) to ensure that the data transfer section 32b can transfer data next. Then, the data transfer section 32a of the first channel performs a given end time process and then outputs, to the CPU 21, an interrupt signal indicating the end of data transfer (TE_DMA1). In response to the interrupt signal, the CPU 21 records the end of data write to the first channel.

During this period, the data transfer section 32b of the second channel performs data transfer to the non-volatile memory units 130c and 130d of the second channel. That is, the cache control section 24 writes each piece of divided data obtained by the division while switching between the non-volatile memory units 130 of different channels from one to another as target locations.

The CPU 21 terminates the process when data transfer for all the channels is complete. This process allows the CPU 21 to perform other process following the DMA setting process. This provides faster response of the SSD device 1 as seen from the host.

When data is read, on the other hand, the CPU 21 determines whether or not data to be stored at the specified LBA as data to be read is stored in the non-volatile memory unit 130, a cache memory. When determining that data is stored therein, the CPU 21 outputs, to the cache control section 24, the channel and the address of the non-volatile memory unit 130 stored in association with the LBA, thus instructing that the data be read from the specified address of the non-volatile memory unit 130 of the channel.

Then, the cache control section 24 outputs the data to be output to the host in response to this instruction. It should be noted that when determining that data to be stored at the specified LBA as data to be read is not stored in the non-volatile memory unit 130, a cache memory, the CPU 21 instructs the flash memory interface 25 to read data from the LBA. Then, the flash memory interface 25 reads the data from the flash memory section 14 and outputs the data to the host in response to this instruction.

The cache control section 24 generates a bit string obtained by connecting pieces of data read from the non-volatile memory units 130a, 130b, and so on of the first, second and other channels, outputting the generated bit string to the CPU 21.

A description will be given next of the operation of the CPU 21 as a whole. When the CPU 21 starts up, it initializes various sections and performs initial setup of the interface of the cache control section 24. Then, if any data was saved to the MRAM at the end of the previous operation, the CPU 21 transfers the saved data to the storage section 22, establishes the interface with the host, and initiates the execution of a loop to wait for a command. As compared to a conventional example using DRAM in which destructive read takes place, this process eliminates the need for transfer of saved data to the storage section 22 and reading of the data into the DRAM again, thus providing faster startup. Further, in a conventional example, it is necessary to write saved data to the flash memory section 14. If a long period of time elapses, so-called data retention, a problem that makes it impossible to read data, may occur. In the example of the present embodiment, such a problem is resolved by using, for example, an FeRAM or an MRAM as non-volatile memory rather than flash memory.

Further, after the startup, the CPU 21 waits for a command from the host. Upon receipt of a command from the host, the CPU 21 performs the process appropriate to the command. More specifically, upon receipt of an instruction to write data to the flash memory section 14 from the host, the CPU 21 receives the data to be written by the instruction from the host. Then, the CPU 21 outputs this data to the cache control section 24, so that the data is stored in the cache memory section 13.

Further, the CPU 21 selectively reads part of the data stored in the cache memory section 13 by a given method and stores the data in the flash memory section 14. Alternatively, the CPU 21 may read part of the data stored in the flash memory section 14 by a given method and instruct the cache control section 24 to write the data to the cache memory section 13. A well-known method can be used to control and manage the caches. Therefore, a detailed description thereof is omitted here.

Further, upon receipt of a data read instruction from the host, the CPU 21 determines whether or not the data is stored in the cache memory section 13. When determining that the data is stored therein, the CPU 21 instructs the cache control section 24 to read the data. On the other hand, if determining that the data is not stored in the cache memory section 13, the CPU 21 reads the data from the flash memory section 14 and outputs the data to the host.

It should be noted that the CPU 21 does not need to store the data, stored in the cache memory section 13, in the flash memory section 14 in preparation for instantaneous interruption of power unlike a conventional SSD device using DRAM as a cache even when a fixed period of time elapses without any command from the host, any background process, or any interrupt from the input/output section 23.

Further, when received an instruction to flush information cached from the host (when instructed to write back information to the flash memory section 14), the CPU 21 ignores this command (does not perform any operation). The reason for this is that it is not likely that data stored in FeRAM or MRAM will be damaged unlike a case in which DRAM is used as a cache.

Alternatively, the CPU 21 may perform the following power saving control when a fixed period of time elapses without any command from the host, any background process, or any interrupt from the input/output section 23. Still alternatively, the CPU 21 may similarly perform power saving control when there is a command input from the host instructing that the SSD device 1 should be placed in standby mode. Among such commands are STANDBY or STANDBY Immediate and SLEEP defined in the PATA or SATA standard. Still alternatively, power saving control may be performed similarly when PHY PARTIAL or SLUMBER is detected by the SSD controller. PHY PARTIAL and PHY SLUMBER are commands that define power saving status for the serial ATA bus itself that connects the peripheral device (SSD) defined in the SATA standard and the host.

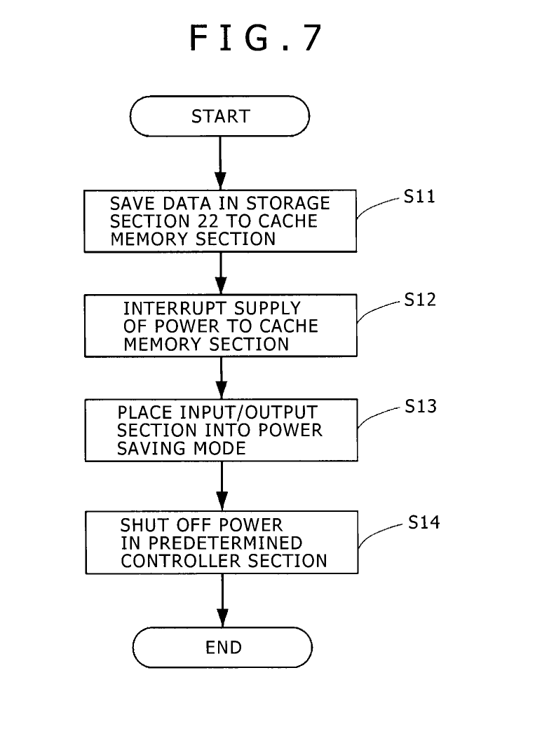

The CPU 21 that proceeds with power saving control reads data stored in the storage section 22 and outputs the data to the cache control section 24 so that the data is stored in the cache memory section 13 as illustrated in FIG. 7 (saving data: S11). When saving of the data stored in the storage section 22 is complete, the CPU 21 causes the cache control section 24 to stop outputting a signal and causes the power supply section 15 to interrupt the supply of power to the cache memory section (S12).

Further, the CPU 21 leaves the input/output section 23 as-is or places the same section 23 in power saving mode (S13) and interrupts the supply of power to the predetermined area of the controller section 11 (S14). As an example, the CPU 21 interrupts the supply of power to the storage section 22 or even to itself. Further, the CPU 21 can also interrupt the supply of power to the cache memory section 13 connected to the cache control section 24. The reason for this is that it is not necessary for the cache memory section 13 to perform any operations for retaining stored information (e.g., refresh operation), which is required, for example, for DRAM.

Then, the input/output section 23 waits until it receives a command (IDLE or IDLE Immediate) input that instructs that the input/output section 23 should be restored to normal mode. Upon receipt of a command (IDLE, IDLE Immediate, or PHY READY) that instructs that the input/output section 23 should be restored to normal mode from the host, the input/output section 23 initiates the supply of power to the CPU 21 and the storage section 22 (after being restored from the power saving mode if it was in the power saving mode).

At this time, the CPU 21 causes the power supply section 15 to initiate the supply of power to the cache memory section 13 and instructs the cache control section 24 to read the saved data from the storage section 22. When the data read by the cache control section 24 in response to this instruction is output to the CPU 21, the CPU 21 stores the data in the storage section 22, thus restoring the data in the storage section 22. Then, the CPU 21 resumes the process based on the data in the storage section 22.

Further, when the supply of power to the SSD device 1 is interrupted, the CPU 21 does not need to transfer saved information from the DRAM to the flash memory section 14, which is required for a conventional SSD using DRAM as a cache. The reason for this is that data is retained in the cache memory section 13 even after the power is interrupted.

In the SSD device 1 of the present embodiment, an error correction code is attached to data to be written to the cache memory section 13. However, the cache control section 24 may divide the error correction code (q bytes) into a plural number equal to or smaller than “n,” the number of non-volatile memory units 130, and cause the different non-volatile memory units 130 to store the divided error correction code. In an example, the cache control section 24 may control the four non-volatile memory units 130 so that ¼ bytes of the one-byte error correction code is written to each of the four non-volatile memory units 130. For example, if each of the non-volatile memory units 130 supports read and write of two bytes at a time, the cache control section 24 divides the q-byte error correction code into q/r (2≦r≦N)-byte pieces when a byte string including the error correction code is written. Then, the cache control section 24 includes the divided pieces of error correction code, each being q/r bytes, in the byte string that contains the error correction code from the beginning (the cache control section 24 generates a new byte string if no byte string is available that contains the error correction code from the beginning), and then stores the byte string in each of the non-volatile memory units 130.

In this case, the cache control section 24 reads the data from each of the non-volatile memory units 130 until the unit of error correction is reached. When the unit of error correction is reached, the cache control section 24 reproduces the error correction code by connecting, in the original order, the divided pieces of the error correction code that are included in the data read from each of the non-volatile memory units 130 in a divided manner. Then, the cache control section 24 corrects errors in the read data using the reproduced error correction code.

In an example of the present embodiment, if the approximate read/write clock frequency (base clock) of the MRAM serving as the cache memory section 13 is 25 MHz, the n=4 non-volatile memory units 130a, 130b, 130c, and 130d (assuming that data can be read and written in two bytes) are used and operated in two separate channels. This eliminates, for example, the need for setting up the address signal lines again between the channels, thus providing shorter overhead time required for memory management (this provides roughly 1.4 to two times (1.5 times on the average) improvement in speed according to a measured value).

According to the measured value, therefore, a read/write speed of 25×4×1.5=150 MB/s or so on the average is achieved. This value is greater than the PATA transfer speed of 133 MB/s and comparable to the SATA transfer speed of 150 MB/s. From the viewpoint of the data transfer speed of the host-side interface, sufficient cache capability can be achieved.

### DESCRIPTION OF REFERENCE NUMERALS

1 SSD device
11 Controller section
12 Interface section
13 Cache memory section
14 Flash memory section
15 Power supply section
21 CPU
22 Storage section
23 Input/output section
24 Cache control section
25 Flash memory interface
31 Channel control section
32 Data transfer section
35 Address setting section
36 Data setting section
37 Arbitration section
130 Non-volatile memory units

1. An SSD (Solid State Drive) device using flash memory, the SSD device comprising:
n (n≧2) non-volatile memory units, each including a non-volatile memory different in type from flash memory; and
a controller adapted to receive data to be written to the flash memory and store the received data in the non-volatile memory units.

2. The SSD device of claim 1, wherein
the controller divides the data to be written to the flash memory into m (2≦m≦n) pieces to generate divided data and writes each of the m pieces of divided data obtained by the division to one of the n non-volatile memory units.

3. The SSD device of claim 1, wherein
the controller divides the data to be written to the flash memory into m (2≦m≦n) pieces to generate divided data and writes each of the m pieces of divided data obtained by the division to one of the n non-volatile memory units while at the same time switching between the n non-volatile memory units, one after another, as the target memory units.

4. The SSD device of claim 3, wherein
the controller divides an error correction code, attached to the data to be written to the flash memory, into m (2≦m≦n) pieces to generate divided data and writes each of the m pieces of divided data obtained by the division to one of the n non-volatile memory units.

5. The SSD device of claim 1, wherein
the controller includes a storage section that includes a volatile memory, and
when determining that the SSD device should be placed in standby mode, the controller interrupts the supply of power to the non-volatile memory units and the storage section after reading data stored in the storage section and writing the data to the non-volatile memory units.

6. The SSD device of claim 5, wherein
when determining that the SSD device should be restored to normal mode, the controller reads data that has been written to the non-volatile memory units and stores the data in the storage section after initiating the supply of power to the non-volatile memory units and the storage section.
